(19) United States
(12) Patent Application Publication
(10) Pub. No.: US 2013/0315708 A1
(43) Pub. Date: Nov. 28, 2013

(54) Nozzle with Extended Tab

(71) Applicant: Jacob Romeo Rendon, Cincinnati, OH (US)

(72) Inventor: Jacob Romeo Rendon, Cincinnati, OH (US)

(21) Appl. No.: 13/480,712

(22) Filed: May 25, 2012

(51) Int. Cl. F03B 11/00; F04D 29/44

(52) U.S. Cl. 415/110; 415/208.2

(57) ABSTRACT

A nozzle feature for sealing leakage in a gas turbine engine having a plurality of nozzle segments within the turbine engine which includes a radially inner band, a radially outer band, at least one vane disposed between the radially inner and outer bands, the radially inner band having a first tab formed in said inner band extending radially downwardly from at least one of first and second circumferential ends.

### BACKGROUND

Present embodiments relate generally to a gas turbine engine. More specifically, the present embodiments relate to limiting leakage at a nozzle within a gas turbine engine.

In a gas turbine engine, air is pressurized in a compressor and mixed with fuel in a combustor for generating hot combustion gases which flow downstream through turbine stages that extract energy from the combustion gases. A high pressure turbine first receives the hot combustion gases from the combustor and includes a stator nozzle directing the combustion gases downstream through a row of high pressure turbine rotor blades extending radially outwardly from a supporting rotor disk. In a two stage turbine, a second stage stator nozzle is positioned downstream of the first stage blades followed in turn by a row of second stage rotor blades extending radially outwardly from a second supporting rotor disk.

The first and second rotor disks are joined to the compressor by a corresponding rotor shaft for powering the compressor during operation. A multi-stage low pressure turbine may or may not follow the multi-stage high pressure turbine and is typically joined by a second shaft to a fan disposed upstream from the compressor.

As the combustion gas flows downstream through the turbine stages, energy is extracted therefrom and the pressure of the combustion gas is reduced. A substantial pressure drop occurs across the second stage turbine nozzle, and an interstage seal is typically provided to seal combustor gas leakage and other airflow around the nozzle.

More specifically, an annular interstage seal ring is mounted axially between the first two rotor disks for rotation therewith during operation, and includes labyrinth seal teeth which extend radially outwardly. A honeycomb stator seal is mounted to the inner end of the second stage nozzle in close proximity to the seal teeth for affecting labyrinth seals therewith and minimizing fluid flow therebetween.

The interstage seal ring includes an annular forward portion which defines a forward cavity on one side of the seal teeth, and an aft portion which defines an aft cavity on the opposite side of the seal teeth.

Each turbine nozzle includes vanes which are hollow and receive a portion of pressurized cooling air from the compressor to cool the vanes during operation. A portion of the vane air is then channeled radially inwardly through the inner band and discharged through corresponding rows of forward and rearward purge holes which supply purged air into the corresponding forward and rearward purge cavities on opposite sides of the sealed teeth. The interstage honeycomb seal typically includes a sheet metal backing sheet or plate which is suitably fixedly attached to corresponding portions of the inner band.

The annular nozzle assembly is formed of a plurality of nozzle segments. Circumferential ends of the nozzle segments are referred to as slash faces. Modern turbine nozzles experience unnecessary leakage through gaps between the honeycomb segments at slash faces on inner bands.

In modern turbine engines, the honeycomb side of a labyrinth seal between the disk and nozzle is often attached directly to the inner band of each nozzle segment, for example by brazing. This may allow for the radial dimensions of the system to be reduced as compared to older structures. However, it necessitates segmenting the honeycomb, which creates a large leakage path between each nozzle segment.

High pressure turbine components must be cooled to meet strength and endurance requirements due to the high gas path temperatures characteristic to this region of the engine. However, gaps between components such as nozzle arrays may allow mixture of cooling air or may allow leakage of high temperature flow from its desired flow path.

A seal between forward and aft cavities is desirable. However, there is currently no known method or structure for limiting axial flow in the area between interstage honeycomb seal structures. Accordingly, it may be desirable to minimize gaps in this area and provide a physical discourager to the leakage flow.

It may be further desirable to provide a physical restriction to the flow.

### SUMMARY

A nozzle feature for sealing leakage in a gas turbine engine having a casing and including a plurality of nozzle segments within the turbine engine which includes a radially inner band, a radially outer band, at least one vane disposed between the radially inner and outer bands, the radially inner band having a first circumferential end and a second circumferential end, a first tab formed in said inner band extending radially downwardly from at least one of the first and second circumferential ends, an extended spline seal engaging the first tab and inhibiting air leakage in an axial direction through the turbine portion of the plurality of nozzle segments.

It would be desirable to develop a structure allowing for the sealing of area between the interstage honeycomb seals which is a source of leakage.

All of the above outlined features are to be understood as exemplary only and many more features and objectives of the nozzle and extended tab may be gleaned from the disclosure herein. Therefore, no limiting interpretation of this summary is to be understood without further reading of the entire specification, claims, and drawings included herewith.

### BRIEF DESCRIPTION OF THE ILLUSTRATIONS

The above-mentioned and other features and advantages of these exemplary embodiments, and the manner of attaining them, will become more apparent and the nozzle feature will be better understood by reference to the following description of embodiments taken in conjunction with the accompanying drawings, wherein:

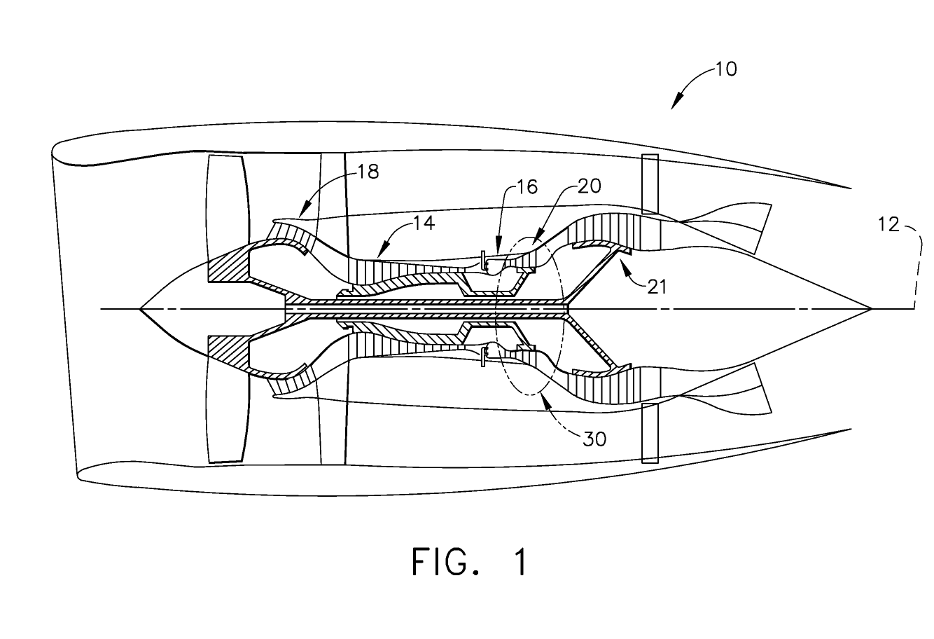

FIG. 1 is a side section view of an exemplary gas turbine engine.

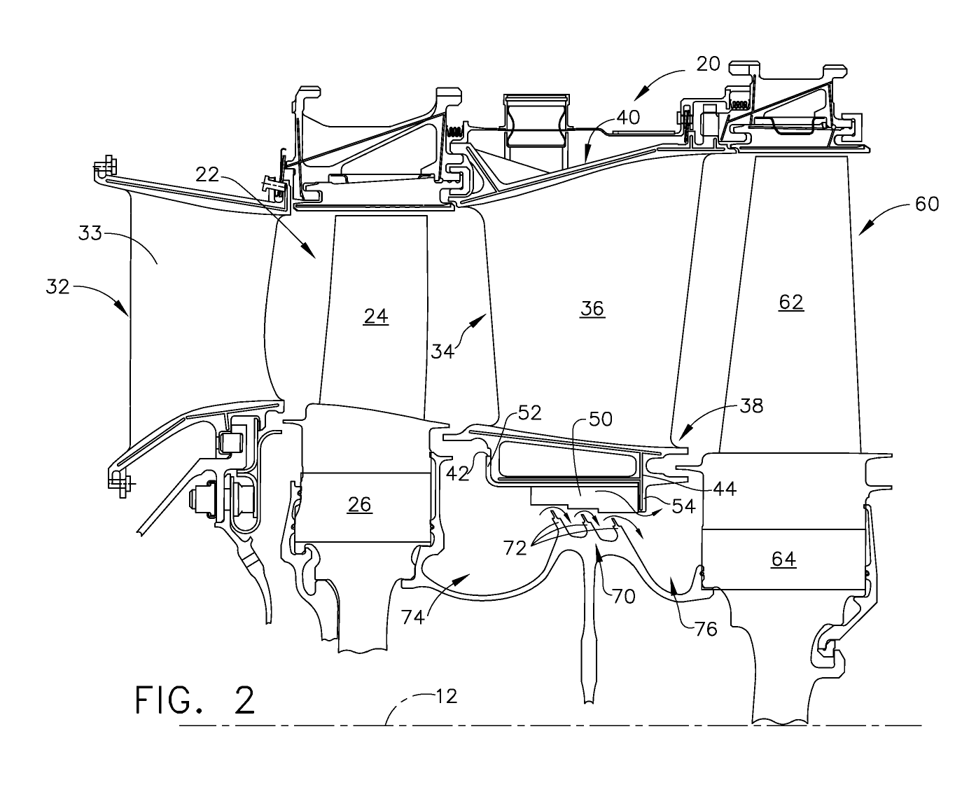

FIG. 2 is a side section view of the high pressure turbine area of the gas turbine engine.

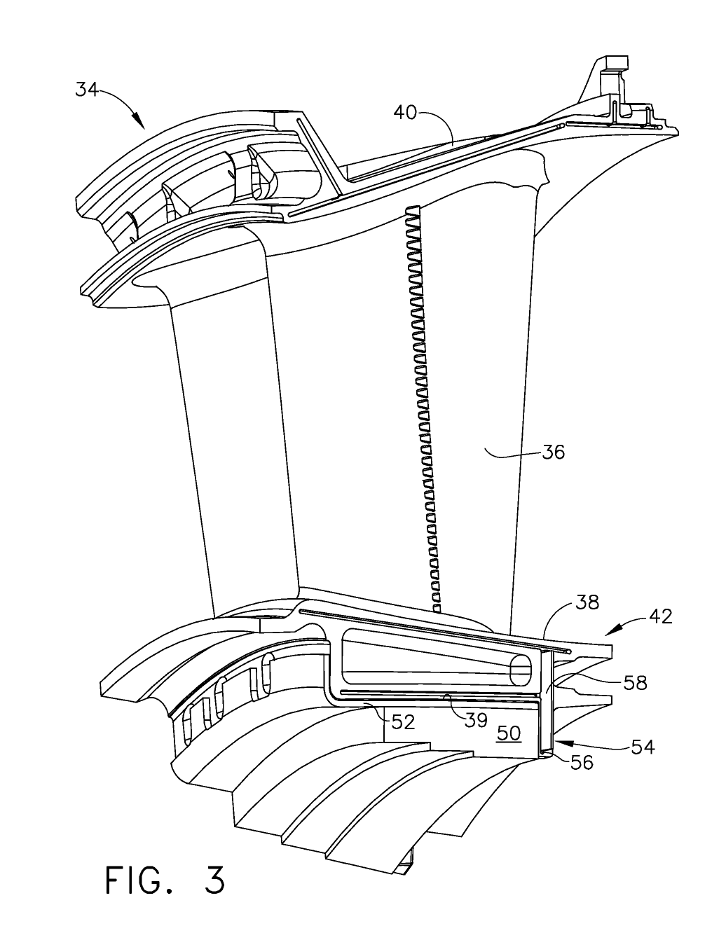

FIG. 3 is an isometric end view of a nozzle depicting the extended tab and spline seal.

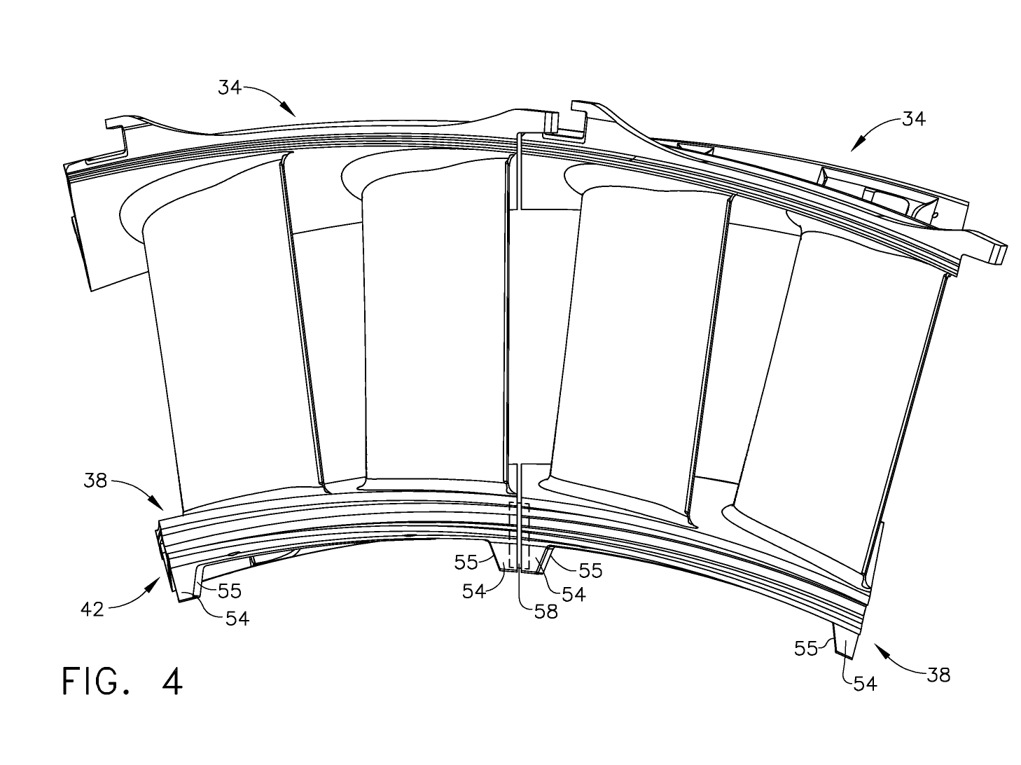

FIG. 4 is a rear isometric view of adjacent nozzle assemblies with adjacent extended spline seals at adjacent circumferential ends.

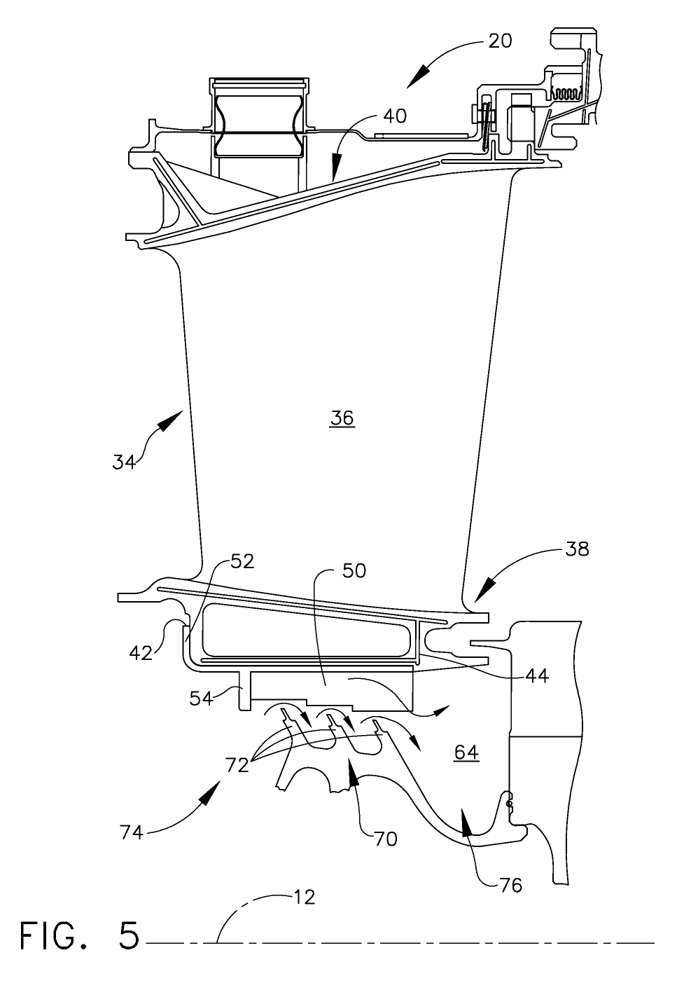

FIG. 5 is a side view of an alternative embodiment with the extended tab at a forward position of the nozzle.

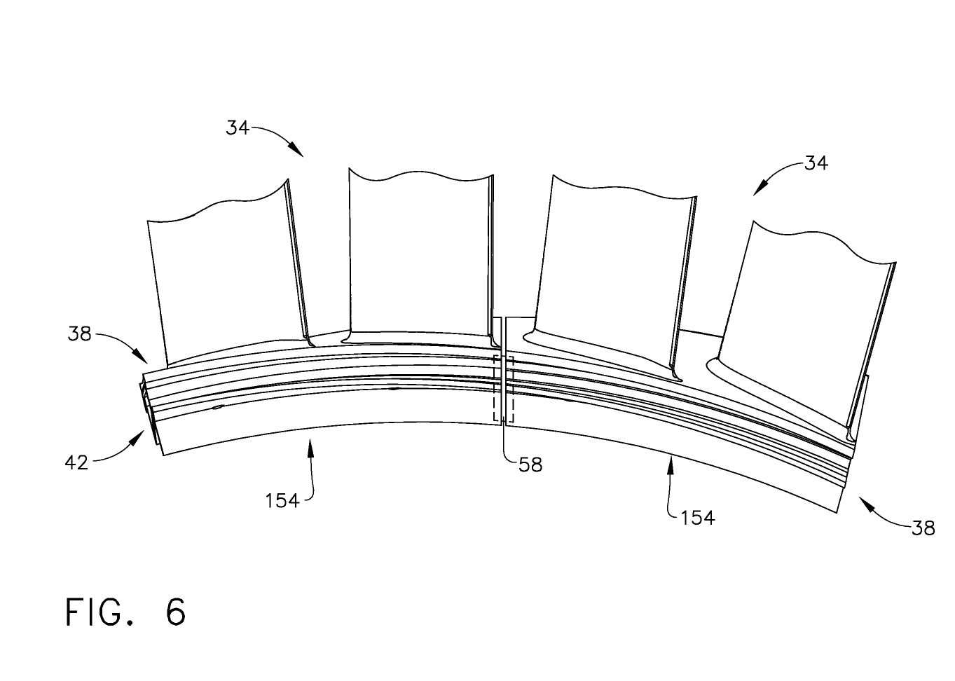

FIG. 6 is a rear view of a nozzle having a continuous tab extending circumferentially.

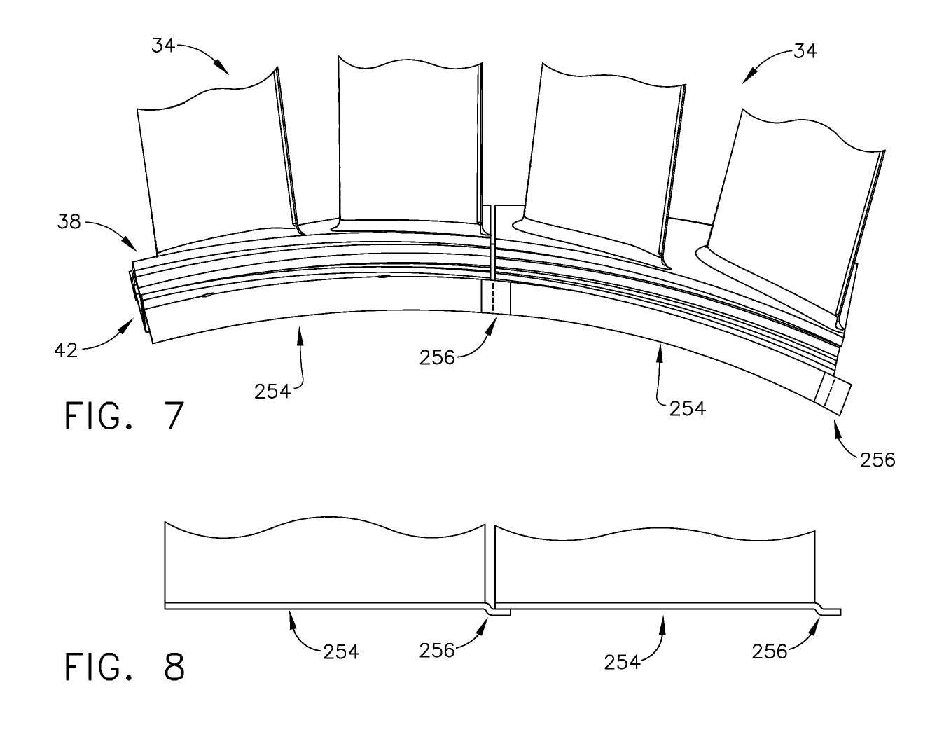

FIG. 7 is a rear view of an alternative tab assembly.

FIG. 8 is a bottom view of the embodiment of FIG. 7.

### DETAILED DESCRIPTION

Reference now will be made in detail to embodiments provided, one or more examples of which are illustrated in the drawings. Each example is provided by way of explanation, not limitation of the disclosed embodiments. In fact, it will be apparent to those skilled in the art that various modifications and variations can be made in the present embodiments without departing from the scope or spirit of the disclosure. For instance, features illustrated or described as part of one embodiment can be used with another embodiment to still yield further embodiments. Thus it is intended that the present invention covers such modifications and variations as come within the scope of the appended claims and their equivalents.

Referring to FIGS. 1-8, various embodiments of a gas turbine engine are depicted having a nozzle and an extended tab structure on an inner band. The inner band nozzle feature inhibits leakage at slash faces where adjacent nozzle segments, in arcuate arrangement about a center line of the gas turbine engine, meet. The extended tab also forms a seat structure for a honeycomb seal.

Referring now to FIG. 1, a schematic side section view of a gas turbine engine 10 is depicted. The exemplary gas turbine engine 10 may be used in a variety of areas including aviation and in marine and industrial areas to power ships, pump oil, compress gas, produce energy or the like. The engine 10 is axisymmetrical about a longitudinal axis or centerline 12 and includes a fan or low pressure compressor 18, depending on the desired use of the turbine engine 10. Following with low pressure compressor or fan 18, air moves through a high pressure compressor 14 wherein air may be further pressurized. Downstream of the compressor 14 wherein the air is pressurized and discharged into a combustor 16 or used through cooling circuits in the gas turbine engine. In the combustor 16 the pressurized air is mixed with fuel and ignited creating a hot combustion gas which is discharged from the combustor 16 through at least a high pressure turbine 20. The high pressure turbine 20 may be, for example, a two-stage high pressure turbine which is separated by a nozzle stator assembly 30 extending about the axial centerline 12 in a circumferential direction. The nozzle stator assembly 30 is depicted generally within a circular broken line. This area indicates where the exemplary embodiments of the nozzle feature are located in the exemplary gas turbine engine 10. However, the extended tab structure may be used in other areas of the engine 10 including, but not limited to, the high and low pressure compressors 14, 18, the low pressure turbine 21 and other areas where leakage may be a concern.

Referring now to FIG. 2, a side view of the high pressure turbine 20 is depicted which receives combustion gas from the combustor 16 (FIG. 1). The exemplary high pressure turbine 20 includes a first stage 22 and a second stage 60. The first stage 22 includes a first stage nozzle 32 and plurality of first stage blades 24. The first stage nozzle 32 is depicted at the left hand side of the figure to receive combustion gas from the combustor 16. The first stage nozzle 32 desirably directs the flow to the first stage blades 24 which are connected to a first stage rotor or disk 26. The blades 24 and disk 26 define a rotor assembly which rotates about the centerline axis 12. After passing through the first stage rotor blades 24, gas continues to a second stage nozzle 34. The second stage nozzle 34 has a stator vane 36 through which combustion gases pass before reaching a second stage turbine blades 62.

High pressure turbine components must be cooled to meet strength and endurance requirements due to the high gas path temperatures characteristic to this region of the engine. As mentioned previously, compressed air may be routed to use as cooling air. However, gaps between components such as nozzle arrays may allow mixture of cooling air or may allow leakage of high temperature flow from its desired flow path.

The first stage turbine nozzle 32 receives combustion gas from the outlet side of the combustor 16 (FIG. 1). The first stage turbine nozzle 32 may have a row of hollow stator vanes 33 fixed between a radially inner band and a radially outer band. After passing through the first stage nozzle 32, the combustion gas reaches an annular arrangement of radially extending first stage blades 24. The blades 24 are connected to a rotor disk 26, both of which rotate about axis 12. Energy of the combustion gas is extracted causing rotation of the blades 24 and rotor 26. The second stage nozzle 34 then redirects combustion gas to a downstream row of second stage blades 62 for further extraction of energy. The blades 62 extend from a second rotor disk 64 which also rotates about the axis 12. The first stage disk 26 and a second stage disk 64 are joined to the rotor assembly of the compressor 14 by a common shaft extending therebetween and energy extracted from the combustion gas by the first stage blades 24 and the second stage blades 62 is utilized to power the compressor during operation of the gas turbine engine 10.

Positioned between the first stage blades 24 and second stage blades 62 is a second stage nozzle 34. The plurality of second stage nozzles 34 define a segmented ring wherein each segment has at least one hollow airfoil or stator vane 36. The exemplary embodiment has a pair of hollow vanes 36. The stator vanes 36 extend between an inner band 38 and an outer band 40. The bands 38, 40 are formed of arcuate segments such that the segments adjoin one another at circumferential ends or slash faces 42 and are sealed together by various seals disposed between the adjacent inner bands 38.

Beneath the second stage nozzle 34 is a rotating interstage seal 70 defined between the first rotor disk 26 and the second rotor disk 64. The interstage seal 70 includes a plurality of labyrinth seal teeth 72 which extend outwardly therefrom toward the second stage nozzle 34. The labyrinth seal teeth 72 extend toward an interstage stator honeycomb seal 50. A thin backing sheet 52 is disposed on the honeycomb seal 50 against the inner band 38. The honeycomb seal 50 is supported from the inner bands 38 of the second stage nozzle 34 and creates a small gap with the seal labyrinth seal teeth 72 to maintain a differential pressure between forward and aft purge cavities 74, 76.

Depending from the inner band 38 is a tab 54 which is cast integrally with the inner band 38 and discourages leakage of air between adjacent honeycomb seals 50 and nozzle segments 34. As an alternative, the tab 54 may be brazed or welded to the inner band 38. The tab 54 depends from the lowermost position of the inner band 38 and is positioned aft of the honeycomb seal 50. The tabs form structures wherein seals may be positioned to discourage or limit flow therebetween. According to some embodiments, a tab 54 is located near each arcuate end of the nozzle inner band 38.

Referring now to FIG. 3, an isometric view of a nozzle segment 34 is depicted with the inner and outer band slash faces 42 shown. The stator nozzle 34 includes the outer band 40, the inner band 38 and the stator vane 36 extending between the inner and outer bands 38, 40. The lowermost surface of the nozzle segment 34 receives a backing sheet 52. This lowermost surface extends circumferentially about the axis 12 (FIG. 2). Depending from the lower edge 39 of the inner band 38 at the aft side of the inner band 38 is the tab 54. The tab 54 may also define a seat for the honeycomb seal 50 which is fitted along the backing sheet 52 at the lower edge 39 of the inner band 38 and the downward extending portion of the tab 54 from the upper portion of the inner band 38. Thus the honeycomb seal 50 may be at least partially supported near the aft end of the nozzle 34 by tab 54, as well as radially above at the lower edge 39.

Extending in a radial direction along the tab 54 is a spline or slot 56. The slot 56 is formed to receive a spline seal 58 within each slot of the tab 54. When nozzle segments 34 are placed in circumferential arrangement about the gas turbine engine 10, slots 56 from adjacent nozzles are aligned so that a spline seal 58 may be positioned between the nozzles 34. The spline seal 58 provides a physical element inhibiting flow between each pair of adjacent nozzles.

Referring now to FIG. 4, a rear isometric view of two adjacent nozzle segments 34 is shown. From the rear view, the inner band 38 is shown with the extended tabs 54 depending radially from the lower edge or surface of the inner band 38. The tab 54 only depends from the inner band 38 at the circumferential ends of the nozzle segment 34. This provides a weight saving feature desirable in avaiation applications. Since the tabs 54 of this embodiment are only at ends of the nozzle 54, weight is limited between ends thereof while only minimal weight is added to nozzle 34 ends. This allows for formation of the seal slot 56 (FIG. 3) at each end and positioning of the spline seals 58.

As depicted in broken line, the exemplary spline seal 58 is rectangular in shape, but may form a variety of shapes. For example, the seal structure 58 may be circular, square, rectangular, other polygons or geometries. The seal 58 may be formed of a singular material or may be a multi-material structure. The seal 58 may change shape at operating temperature as well. The seal 58 has a volumetric thermal expansion coefficient which is a thermodynamic property of the material. For example, the volumetric thermal expansion can be expressed as α_{V}=(1/v)(ΔV/ΔT), where α_{V}is the volumetric thermal expansion coefficient, V is the volume of the material and ΔV/ΔT with respect to the change in volume of the material with respect to the change in temperature of the material. Thus the volumetric thermal expansion coefficient measures the fractional change in volume per degree change in temperature at a constant temperature.

As shown in the figure, when the adjacent nozzles are positioned in their annular arrangement, the tabs 54 are positioned adjacent one another and the seal 58 is positioned in each tab to block an air flow path which would otherwise allow flow between adjacent honeycomb seals 50 (FIG. 3). With this arrangement, the tab feature 54 with spline seal 58 reduce the leakage between slash faces 42 by up to about 50%.

According to some embodiments, and with reference to FIG. 5, the tabs 54 may be moved from an aft position on the inner band 38 to a forward position. The forward position may be at any location along the lower surface of the inner band 38. For example, the tab 54 may be moved to an axial forward end of the inner band or maybe moved to places between the forward end and the aft end of the nozzle 34. According to the instant embodiment, the honeycomb seal 50 may be supported from either or both of the front of the seal 50 and from above.

According to some embodiments, and with reference now to FIG. 6, where weight issues are not a primary concern as they are in aviation, the tabs 154 may be extended in a circumferential direction to form a curvilinear feature 154 extending along a lower surface of the inner band 38 rather than merely at the circumferential ends or slash faces 42. The ends of the curvilinear 154 feature may include splines for positioning of spline seals. Alternatively, the ring may be formed of two semi-circular pieces that extend about the entire assembly of nozzle segments 42 so splines may only be needed at ends of the two semi-circular pieces. The elongate curvilinear tab feature 154 may be integrally formed, or formed separately and subsequently welded or brazed on the nozzle inner band 38.

According to further embodiments, the tabs 54, 154 could be brazed or welded as well as the previously described cast structures. Similarly, the tabs 54 may include a brazed, welded or integrally formed seal structure 58.

In any of these embodiments, the tab 54 could be utilized as the flow inhibiter without the use of the spline seal by forming or adding an additional lip or seal structure extending from the tab 54, rather than using a spline 56 formation. Thus the lips of adjacent tabs would overlap and inhibit flow between adjacent honeycomb seals 50. For example, referring to FIGS. 7 and 8, alternate embodiments of the tabs are shown wherein depending from the inner band 38 are continuous tabs 254. These tabs 254 may be used where weight reduction is not a bigger concern such as non-aviation turbine usage. The tabs 254 extend circumferentially along the lower aft edge of the nozzle 34. The tabs 254 may alternatively be at other locations than the aft-most position. Additionally, the tabs 254 may further include end laps 256 which extend beyond the nozzle to the adjacent nozzle. Thus the gap between adjacent nozzles covered by lap 256. This embodiment may be used with or without the seal 58. Additionally, it should be understood that the laps may be utilized with the discontinuous tabs 54 as well as the continuous tabs 254.

While multiple inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Examples are used to disclose the embodiments, including the best mode, and also to enable any person skilled in the art to practice the apparatus and/or method, including making and using any devices or systems and performing any incorporated methods. These examples are not intended to be exhaustive or to limit the disclosure to the precise steps and/or forms disclosed, and many modifications and variations are possible in light of the above teaching. Features described herein may be combined in any combination. Steps of a method described herein may be performed in any sequence that is physically possible.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A nozzle feature for sealing leakage in a gas turbine engine, comprising:
a radially inner band, a radially outer band, at least one vane disposed between said radially inner and outer bands;
said radially inner band having a first circumferential end and a second circumferential end;
a first tab formed in said inner band extending radially downwardly from a lowermost surface near at least one of said first and second circumferential ends; and,
an extended spline seal engaging said first tab inhibiting air leakage in an axial direction between adjacent said annularly arranged nozzle segments.

2. The nozzle feature of claim 1, said tab having a spline for receiving said extended spline seal.

3. The nozzle feature of claim 1 further comprising said first tab at said first circumferential end and a second tab at said second circumferential end.

4. The nozzle feature of claim 3 wherein said tabs extends along said lowermost surface between said first end and said second end.

5. The nozzle feature of claim 4, said first and second tabs extending circumferentially toward first and second tabs of said adjacent nozzle segments.

6. The nozzle feature of claim 1 further comprising said tab being disposed toward said aft end of said inner band.

7. The nozzle feature of claim 1 further comprising said tab being disposed toward said forward end of said inner band.

8. A nozzle feature for sealing leakage, comprising:
a first honeycomb seal structure and a second honeycomb seal structure located in circumferential arrangement about a rotor in a turbine portion of a gas turbine engine;
a first nozzle assembly having an inner band, an outer band and at least one vane extending between said inner and outer bands;
a first radial tab extending from said inner band at circumferential ends of said inner band;
one of said honeycomb seal structures disposed adjacent said radial tab on an upstream side of said radial tab; and,
an extended spline seal engaging said radial tab and extending between said first and second honeycomb seal structures.

9. The nozzle feature of claim 8 further comprising a second nozzle assembly receiving said second honeycomb seal structure.

10. The nozzle feature of claim 9, said extended spline seal engaging a second radial tab of said second nozzle assembly.

11. The nozzle feature of claim 9 further comprising a spline in a circumferential end of said radial tab.

12. The nozzle feature of claim 11 further comprising a second opposed spline in said second radial tab.

13. A nozzle feature for a gas turbine engine, comprising:
a radially inner band and a radially outer band;
a vane extending between said inner band and said outer band;
said radially inner band having a first slash face and a second slash face; and,
a tab extending radially from a lower surface of said radially inner band at said first slash face.

14. The nozzle feature of claim 13 further comprising laps extending from a tab to an adjacent nozzle discouraging airflow between adjacent said nozzles.

15. The nozzle feature of claim 13 further comprising a seal extending from said first tab and inhibiting air leakage between adjacent said nozzles.

16. The nozzle feature of claim 13, said tab located at an aft end of said radially inner band.

17. The nozzle feature of claim 13 wherein said tab is at one of an axial forward end of said nozzle, an axial aft end of said nozzle or therebetween.

18. The nozzle feature of claim 13 further comprising a slot extending from an upper end of said inner band to a lower end of said inner band.

19. The nozzle feature of claim 13 wherein said tab is one of cast integrally brazed or welded on said radially inner band.

20. The nozzle feature of claim 13 wherein said tab extends circumferentially along a lower edge of said radially inner band.
